(19) United States
(12) Patent Application Publication
(10) Pub. No.: US 2013/0164429 A1
(43) Pub. Date: Jun. 27, 2013

(54) Puffed Cheese Product and Process for Making Same

(71) Applicants: Greg Stromotich, Burnaby (CA); Terumi Stromotich, Burnaby (CA); Darrell Thune, Abbotsford (CA)

(72) Inventors: Greg Stromotich, Burnaby (CA); Terumi Stromotich, Burnaby (CA); Darrell Thune, Abbotsford (CA)

(21) Appl. No.: 13/822,074

(22) PCT Filed: Sep. 13, 2011
(86) PCT No.: PCT/CA11/01033

§ 371 Date: Mar. 11, 2013

Related U.S. Application Data
(60) Provisional application No. 61/382,473, filed on Sep. 13, 2010.

(51) Int. Cl. A23C 19/14

(52) U.S. Cl. CPC A23C 19/14
USPC 426/582; 426/447

(57) ABSTRACT

Partially dehydrated cheese products that may be consumed as a puffed cheese snack, and that may be stored for extended periods of time prior to consumption or reconstitution are provided, as are methods for making the same. Precursor cheese having a suitable fat content and moisture content is formed into pieces suitably sized for processing, optionally treated to facilitate the free flow of the formed pieces relative to one another, chilled and then vacuum micro-waved to cause the precursor cheese pieces to become partially dehydrated and puffed. Optionally, microwave heating may be reduced in a gradual or step-wise fashion during the second half of the vacuum microwave drying step in order to minimize the elevation of heat in the fats of the cheese pieces while still allowing water vapour (i.e. heat) to escape therefrom. Microwave heating is then discontinued and vacuum reduced to enable the puffed cheese pieces to give off their thermal energy and cool in a controlled fashion while maintaining their puffed size. Atmospheric pressure is then reintroduced immediately or in the course of several minutes, dependant on the amount of fat, moisture level and temperature of the puffed cheese product. The final moisture content/water activity of the puffed cheese product is selected empirically with reference to desired shelf life, and is dependent in part upon the salt content of the precursor cheese.

### TECHNICAL FIELD

The present disclosure relates to the production of partially dehydrated cheese products that may be consumed as a puffed cheese snack, and that may be stored for extended periods of time prior to consumption or reconstitution.

### BACKGROUND

Various methods and processes for the dehydration of foodstuffs and for the creation of puffed cheese food products are known. By way of example, U.S. Pat. No. 6,312,745 describes a process for drying antioxidant-rich berries (such as blueberries) to preserve their antioxidant action, and U.S. Pat. Nos. 4,803,090 and 7,521,078 6,312,745 describe processes for producing puffed cheese food products. There nevertheless remains a need for puffed cheese products having pleasant visual and organoleptic qualities, and that may be stored for extended periods of time prior to consumption or reconstitution, and the present disclosure provides such products and methods of making the same.

### SUMMARY

This summary is not an extensive overview intended to delineate the scope of the subject matter that is described and claimed herein. The summary presents aspects of the subject matter in a simplified form to provide a basic understanding thereof, as a prelude to the detailed description that is presented below. Neither this summary nor the following detailed description purports to define or limit the invention; the invention is defined only by the claims.

By way of a general overview, a method for making a partially dehydrated, puffed cheese product is provided, together with the product created thereby. Precursor cheese having a fat content of between roughly 10% and 45% and a moisture content of between roughly 10% and 80% is formed into pieces suitably sized for processing and for yielding a puffed cheese product that is of a desired configuration and size. The surfaces of the pieces are then optionally treated to enable them to flow freely relative to one another, and then chilled to roughly 4° C. or frozen.

The precursor cheese pieces are then vacuum microwaved at between roughly −92 kPa and −101 kPa and between roughly 0.2 kW/kilogram and 4.0 kW/kilogram for between roughly 10 and 40 minutes, thereby causing the precursor cheese pieces to become partially dehydrated and puffed. Optionally, microwave heating may be reduced in a gradual or step-wise fashion during the second half of the vacuum microwave drying step in order to minimize the elevation of heat in the fats of the cheese pieces while still allowing water vapour (i.e. heat) to escape therefrom.

Microwave heating is then discontinued and vacuum reduced to between roughly −75 kPa and −101 kPa for between roughly 4 and 15 minutes to enable the puffed cheese pieces to give off their thermal energy and cool in a controlled fashion while maintaining their puffed size. Atmospheric pressure is then reintroduced immediately or in the course of several minutes, dependant on the amount of fat, moisture level and temperature of the puffed cheese product. The final moisture content/water activity of the puffed cheese product is selected empirically with reference to desired shelf life (in accordance with principles well known to those of skill in the art), and is dependent in part upon the salt content of the precursor cheese.

### BRIEF DESCRIPTION OF THE DRAWINGS

For a fuller understanding of the nature and advantages of the disclosed subject matter, as well as the preferred mode of use thereof, reference should be made to the following detailed description, read in conjunction with the accompanying drawings. In the drawings, like reference numerals designate like or similar steps or components.

FIG. 1 is a flowchart depicting a process for making a dehydrated, puffed cheese product in accordance with an embodiment of the disclosed subject matter.

### DETAILED DESCRIPTION OF SPECIFIC EMBODIMENTS

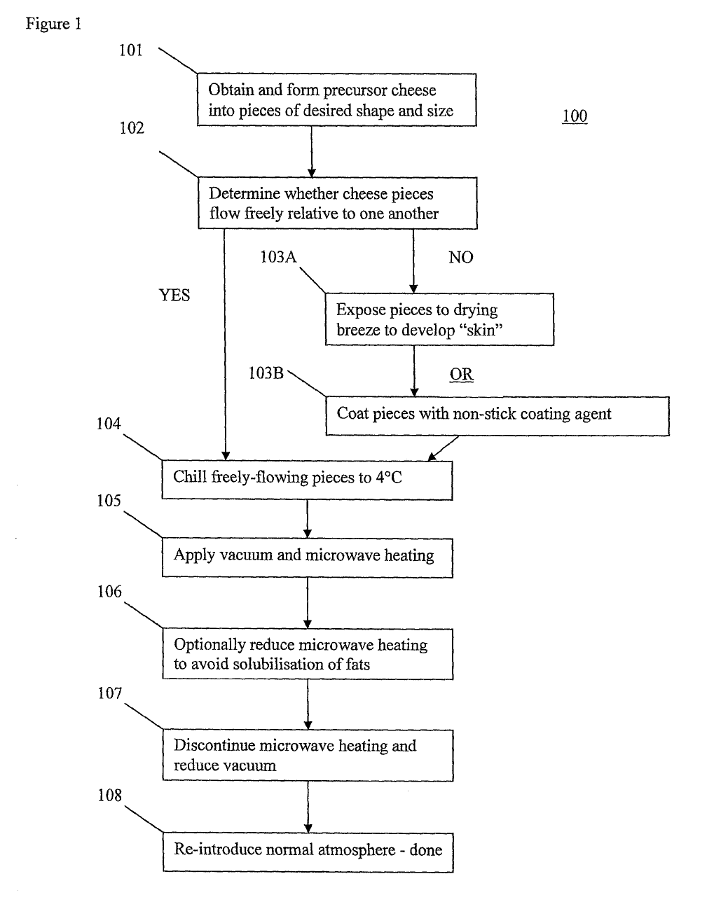

Referring to FIG. 1, a process 100 for making a dehydrated, puffed cheese product from a precursor cheese as described in further detail herein is shown. By way of example, the precursor cheese from which the dehydrated, puffed cheese product is made may be fresh mozzarella. However, any homogeneous mixture of dairy products or cheese analogues (such as, for example, feta cheese, gelled yogurt, processed American cheese, etc.) having a fat content of between roughly 10% and 45% (ideally around 18%) and a moisture content of between roughly 10% and 80% (ideally around 55%) may also be used.

At step 101, the precursor cheese is obtained and cut or formed into pieces that are suitably sized for processing and for yielding a dehydrated, puffed cheese product that is of a desired configuration and size. If, for example, the resulting puffed cheese product is intended to be consumed as a bite-sized snack food, then precursor mozzarella cheese may ideally be cut into roughly 6 mm cubes. However, differently-shaped (e.g. wafers, cylinders, rectangles, etc.) and differently-sized pieces having a main dimension or cross-section of up to roughly 15-20 mm may also be used, depending upon the moisture content of the precursor cheese and upon the desired configuration of the puffed snack cheese product. The upper limit on the size of the precursor cheese pieces is determined empirically for each precursor cheese, and dictated by the ability of the microwaves applied during later processing (described below) to reach through and evenly heat the pieces. If the selected main dimension or cross-section of the pieces is too large relative to the moisture content of the precursor cheese, such that the microwaves cannot reach therethrough during processing, then the surface of the pieces may become prematurely dried, thereby inhibiting puffing. If the dehydrated, puffed cheese product is primarily intended instead for long-term storage and later reconstitution and use as melted cheese (as, for example, a pizza topping), then smaller sized pieces down to powder-sized pieces may be preferred.

The pieces of precursor cheese obtained from step 101 are then examined 102 to determine whether they stick to one another, or whether they flow freely relative to one another. If the pieces stick to one another, then they may alternatively: (a) be exposed 103A to a drying breeze (preferably at roughly 4° C.) to promote the development of a non-stick “skin”; or (b) tumbled or otherwise mixed 103B with a coating agent such as starch, cellulose, or dry (having less than 5% moisture content) cheese powder in order to provide a light non-stick coating to the surface thereof. In alternate embodiments in which the cheese pieces are mechanically separated from one another (such that they will not come into contact with one another during later processing), examination 102 step and/or coating 103A/103B step may be omitted.

Once the pieces of precursor cheese are free flowing, they are chilled 104 to roughly 4° C. or frozen until ready for further processing. If the free-flowing precursor cheese pieces are frozen, subsequent puffing may be expected to result in larger, less uniform air inclusions.

The chilled free-flowing precursor cheese pieces are then placed into a vacuum microwave, where they are subjected 105 to a vacuum level of between roughly −92 kPa and −101 kPa and microwave heating at between roughly 0.2 kW/kilogram and 4.0 kW/kilogram for between roughly 10 and 40 minutes that causes the precursor cheese pieces to become partially dehydrated and “puffed” to a size that is at least about 10% to 1000% greater than their original size. The amount of microwave heating applied and the time period of heating will determine the final moisture level and degree of puffing, and for ideal precursor cheese pieces cut from mozzarella into 6 mm cubes and having 18% fat content and 55% moisture content, a vacuum level of roughly −96 kPa and microwave heating at roughly 0.6 kW/kilogram may be applied for roughly 20 minutes.

Both the vacuum level and the amount and duration of microwave heating applied in the vacuum microwave are dependent primarily upon the percentage fat content of the precursor cheese. The fat in higher fat content cheeses tends to solubilise at lower heat levels than does the fat in lower fat content cheeses. To counteract this undesirable effect, the amount of vacuum is increased towards −101 kPa as the fat content in the precursor cheese pieces increases towards 45%. At lower pressures, the water in the precursor cheese pieces is more easily excited into vaporization, so the same degree of puffing can be obtained with higher fat content cheeses at correspondingly lower vacuum levels. Additionally or alternatively, the duration of heating may be increased and/or the overall amount of heating may be decreased to achieve similar effects.

In preferred embodiments, the amount of microwave heating applied in the vacuum microwave is lowered 106 gradually or in stepwise fashion during the second half of the vacuum microwave drying step in order to minimize the elevation of heat in the fats of the cheese pieces while still allowing water vapour (i.e. heat) to escape therefrom. If excess heat is allowed to build up in the core of the cheese pieces, it may solubilise the fats in the cheese pieces, which may in turn result in sub-optimal optic and/or organoleptic qualities of the resulting dehydrated, puffed cheese product. The degree and fashion (i.e. gradual or stepwise) of lowering is determined empirically based primarily upon the precursor cheese used. However, in general, gradual lowering may be preferred when the vacuum microwaving is conducted in a batch process, and stepwise lowering may be preferred in multi-chamber vacuum microwave processes.

After the precursor cheese pieces have been subjected to vacuum and microwave heating in the vacuum microwave as described above to cause them to become “puffed”, the microwave heating is discontinued and the amount of vacuum is preferably reduced 107 to between roughly −75 kPa and −101 kPa (ideally around −85 kPa) for roughly 4 to 15 minutes to enable the puffed cheese pieces to give off their thermal energy and cool in a controlled fashion while maintaining their puffed size. The degree to which the atmosphere is reapplied at this step 107 is again dependent upon the fat content of the precursor cheese, and if this step is omitted, there is a greater likelihood that the puffed cheese pieces may collapse during cooling. In a typical embodiment, minimal change is achieved after 10 minutes at the reduced vacuum level.

The dehydrated, puffed cheese product may then be reintroduced 108 to normal atmospheric pressure. Depending upon the amount of fat, moisture level and temperature of the puffed cheese product, this process can be done immediately or in the course of several minutes. The dehydrated, puffed cheese product exits at a temperature of between 17° C. and 65° C., and may optionally be tumbled during the cooling process to accelerate cooling. Once cooled, the dehydrated, puffed cheese product becomes crisper and more rigid.

The final moisture content/water activity of the puffed cheese product is selected empirically with reference to desired shelf life (in accordance with principles well known to those of skill in the art), and is dependent in part upon the salt content of the precursor cheese. In general, the moisture present in foods protects the fats therein from oxidization, so as moisture content is reduced, the risk of oxidization is correspondingly increased.

The dehydrated, puffed cheese product made by the process described above may be consumed immediately or packaged in moisture-tight container to maintain the lower moisture levels below that of the atmosphere. In this form, the dehydrated, puffed cheese product can be stored for extended periods of time at room temperatures. Packaging in modified atmospheric packaging environments may reduce the rate of the oxidation of fatty acids within the cheese puffed cheese product, thereby extending shelf life even further.

The dehydrated, puffed cheese product may also be reconstituted by misting with water and allowing it to sit at roughly 4° C. Puffed cheese product moistened in this fashion may then be melted to provide a melted cheese product of the sort typically used as, for example, a pizza topping. If the puffed cheese product is not moistened prior to heating, it may burr (i.e. brown) without fully melting.

The following examples illustrate the application of the process according to the present disclosure to mozzarella cheese having roughly 58% moisture content and 18% fat content.

### EXAMPLE 1

2 Kg of Mozzarella cheese was diced into 6 mm cubes, powdered with 50 grams of potato starch, and vacuum drawn to 96% for 5 minutes. Three cycles of microwaves 3.6 kW were applied for 4 minutes as vacuum was increased to 99%. Microwave heating was reduced to 1 kW through two further cycles, then discontinued while vacuum level was dropped 25% over 8 minutes. Vacuum was then discontinued. The resulting puffed cheese product presented as 25 mm diameter spheres with uniform air pockets throughout.

### EXAMPLE 2

The process of Example 1 was varied by decreasing cycle time by one half and doubling the number of cycles. The resulting puffed cheese product presented as 25 mm diameter spheres with somewhat more irregular air pockets throughout. Increasing the rate of tumbling of the cheese pieces on a conventional vacuum microwave conveyor achieves a smoother surface appearance of the puffed cheese product spheres.

The present description is of the best presently contemplated mode of carrying out the subject matter disclosed and claimed herein. The description is made for the purpose of illustrating the general principles of the subject matter and not be taken in a limiting sense; the claimed subject matter can find utility in a variety of implementations without departing from the scope and spirit of the invention made, as will be apparent to those of skill in the art from an understanding of the principles that underlie the invention. All percentages, ratios and amounts specified herein are by weight unless indicated otherwise. The technical disclosures of all documents referred-to herein are fully incorporated by reference as if fully set forth herein.

We claim:

1. A method for making a puffed cheese product comprising:
providing a precursor cheese having a fat content of between roughly 10% and 45% and a moisture content of between roughly 10% and 80%;
forming the precursor cheese into pieces suitably sized for processing and for yielding a puffed cheese product that is of a desired configuration and size;
optionally treating the surfaces of the precursor cheese pieces to enable the precursor cheese pieces to flow freely relative to one another;
chilling the precursor cheese pieces to roughly 4° C.;
vacuum microwaving the precursor cheese pieces at between roughly −92 kPa and −101 kPa and between roughly 0.2 kW/kilogram and 4.0 kW/kilogram for between roughly 10 and 40 minutes, thereby causing the precursor cheese pieces to become partially dehydrated and puffed;
discontinuing microwave heating and reducing vacuum to between roughly −75 kPa and −101 kPa for between roughly 4 and 15 minutes; and,
reintroducing the puffed cheese pieces to atmospheric pressure.

2. The method of claim 1, wherein the microwave heating is reduced during the second half of the vacuum microwave drying step.

3. A puffed cheese product made by the method of claim 1.
